(19) United States
(12) Patent Application Publication
(10) Pub. No.: US 2022/0091010 A1
(43) Pub. Date: Mar. 24, 2022

(54) METHOD FOR DETECTING THE CONCENTRATION OF ORGANIC PARTICLES IN THE AIR AND APPARATUS THEREFOR

(71) Applicant: ebm-papst neo GmbH & Co. KG, Mulfingen (DE)

(72) Inventors: Ralph WYSTUP, Kuenzelsau (DE); Frederik WYSTUP, Neuenstein (DE)

(21) Appl. No.: 17/482,187

(22) Filed: Sep. 22, 2021

(30) Foreign Application Priority Data
Sep. 23, 2020 (DE) 10 2020 124 740.0

(51) Int. Cl. G01N 15/06

(52) U.S. Cl. CPC G01N 15/06; G01N 2015/0693; G01N 2015/0687

(57) ABSTRACT

A method for detecting concentration of organic particles (14), in particular viruses, with a determined target diameter in air (10) comprises organic and/or inorganic aerosol particles. Aerosol particles contained in the air (10) are bound in a fluid (40), so that said aerosol particles are contained as particles in the fluid (40). The fluid (40) with particles is exposed in measurement chamber (30) to a second light (B) fragmenting the organic particles and/or to an ultrasound (C) fragmenting the organic particles in the fluid (40). Before fragmentation of organic particles, a first light scattering of a first light (A) and after the fragmenting of organic particles, a second light scattering of the first light (A) on the fluid (40) are determined. Using difference between the first light scattering and the second light scatterings, the concentration of the organic particles (14) in the fluid (40) and thus in the air is determined.

### FIELD

The disclosure relates to a method for detecting the concentration of organic particles with a determined target diameter in the air and to a sensor or to an apparatus for detecting the concentration of organic particles with a determined target diameter in the air.

### BACKGROUND

Numerous diseases and pathogens, in particular disease-causing viruses, exist, which spread via the air and in particular via aerosols and which are thus present in the air as aerosol particles. Therefore it is desirable to be able to detect such viruses in the air and to determine their concentration in the air and thus a possible risk of infection.

For a first assessment of whether pathogens are present in the air and for an assessment of the risk associated with the potentially present pathogens, it is not necessary at first to know precisely which pathogens or viruses are involved, but only that such pathogens are present with a certain probability and with or in a certain concentration.

An aerosol is, however, a heterogeneous mixture (dispersion) of solid and/or liquid suspended particles in a gas, for example, air. The suspended particles are referred to as aerosol particles, wherein such aerosol particles can be, for example, dust, pollen, spores, bacteria or viruses, so that a simple measurement of the aerosol particles and thus an assessment of whether pathogens are present is not possible without difficulty.

Basic methods for determining the concentration of viruses in the air are in fact known in the prior art, but they are predominantly based on laboratory methods with correspondingly time-consuming analyses, so that the known methods are complicated, expensive and above all also time-consuming. Therefore, the known methods cannot be used for a short-notice warning against pathogens, since the analysis results would simply usually become available too late.

In addition, the known methods are usually adapted to a single, very specific, virus, or, in general, to a single specific pathogen and they are often not applicable to other pathogens, so that with such methods the concentration or the presence of a wide variety of pathogens in the air cannot be determined.

SUMMARY:

The technical solution provided by example embodiments of the disclosure overcomes the aforementioned disadvantages and provides a method and an associated sensor or an associated apparatus by means of which a presence or a concentration of pathogens and in particular of viruses in the air can be determined with sufficient probability.

This technical solution is achieved by the combination of features according to claim 1, for example.

The basic idea of an example embodiment of the disclosure is to provide a method by means of which, in a sample of air, particles with a determined target diameter can be fragmented or comminuted by irradiation with a light and/or ultrasound directed onto these particles, wherein, by measurements of the light scattering of light on the sample, it is determined how high the concentration of the fragmented or comminuted particles in the sample is, from which the concentration of the particles with the target diameter in the air is determined.

Here, the particles with the determined target diameter correspond to the potential pathogens, so that the target diameter is preferably selected in accordance with the pathogens to be detected and wherein light is set in particular with regard to its wavelength, intensity and/or pulsing, so that the particles with the determined target diameter are excited to a vibration which comminutes or fragments the particles, by means of which the particles with the determined target diameter are destroyed and fragmented that is to say comminuted preferably disproportionally in comparison to particles with other diameters.

Proposed according to an example embodiment is a method for detecting a concentration of organic particles, in particular viruses, with a determined target diameter in air which contains organic and/or inorganic aerosol particles. For this purpose, aerosol particles contained in the air and preferably in a predetermined air volume of the air are first bound in a fluid, so that they are contained in the fluid as particles. Subsequently, the fluid with the particles contained therein is exposed in a measurement chamber to a second light which fragments the organic particles and/or to ultrasound which fragments the organic particles, so that the organic particles in the fluid are fragmented, thus comminuted, whereby the light scattering behavior of the fluid or of the particles bound in the fluid changes. Before the fragmentation of the organic particles, a first light scattering of a first light is determined, and after the fragmentation of the organic particles, a second light scattering of the first light on the fluid is determined, which can vary due to the fragmentation of potentially present organic particles. From a difference or from a comparison of the first light scattering and the second light scatterings, the concentration of the organic particles in the fluid and thus in the air or in the predetermined air volume, from which the particles were transferred into the fluid, is determined.

A method which is also based on a fragmentation of particles and a differential measurement and which is used for detecting a concentration of organic particles in the air, but which is different and teaches a differently constructed apparatus, is also known from the German application with reference number DE 10 2020 120 199.0. The entire disclosure of the mentioned German application which was initiated by the applicant of the present application is hereby included in the present application by reference.

The organic particles such as, for example, viruses in general represent a body which can be set in vibration, wherein one can simply imagine a body with ball-shaped or spherical sheath. If the particle vibrates sufficiently intensively, this leads to a breaking apart of this sheath or of the particle, whereby the pathogen can be deactivated and the particle “shatters” or is fragmented into smaller parts. The vibration or the intensity of the vibration here depends on the wavelength of the light exciting the vibration and on the intensity of the light as well as on a duration of irradiation or a pulsing. With regard to an/exposure to ultrasound, the vibration is in particular a function of the frequency of the ultrasound, which can also lead to a vibration fragmenting the particles. By setting the wavelength of the light and/or the frequency of the ultrasound to a resonance range which is determined by the respective type of particle and is a function of its diameter, such an effect can be intensified or be achieved already with a relatively low energy use, since less energy needs to be used to “destroy” or shatter the particles. A destroyed particle comprising multiple parts, which previously had a diameter corresponding to the target diameter, possesses light scattering properties which are varied in comparison to the whole particle, since the light is no longer scattered by an individual particle but by its smaller individual components or fragments.

In particular, it is provided here that the fragmentation of the organic particles and the determination of the first light scatterings and of the second light scattering are carried out offset in time with respect to one another in a single measurement chamber, so that a simple design of the apparatus used for this purpose can be implemented.

A particularly advantageous variant of the method is one which has the following steps in the following order:

a) binding aerosol particles contained in air in the preferably aqueous fluid, so that the fluid contains the aerosol particles previously contained in the air as particles; the fluid is therefore preferably a colloidal solution or a colloidal suspension;

b) guiding the fluid into the measurement chamber, which can be exposed to light emitted by a light source, wherein the guiding of the fluid can be implemented in particular via a flow channel provided for this purpose or a pipe system;

c) exposing the fluid in the measurement chamber to the first light of first intensity and first wavelength, wherein the first intensity and the first wavelength are selected so that by the first light no or substantially no organic particles are fragmented;

d) determining the first light scattering of the first light on the fluid in the measurement chamber, wherein the light scattering of the first light on the particles in the fluid arises preferably due to the Tyndall effect which is also referred to as Rayleigh effect and which can accordingly be measured;

e) exposing the fluid in the measurement chamber to the second light of second intensity and second wavelength, wherein the second intensity and the second wavelength are selected so that the organic particles are fragmented by the second light, and/or exposing the fluid in the measurement chamber to ultrasound, wherein a frequency of the ultrasound is selected in such a manner that the organic particles are fragmented, where the frequency of the ultrasound is preferably selected so that substantially exclusively the particles with the target diameter are fragmented, and wherein furthermore both the ultrasound and the second light can be pulsed;

f) exposing the fluid in the measurement chamber to the first light, so that comparable measurement results can be determined by the subsequent determination of the second light scattering;

g) determining the second light scattering of the first light on the fluid in the measurement chamber, wherein said second light scattering is determined analogously to the first light scattering;

h) determining the difference between the first light scattering and the second light scattering, and determining the concentration of the organic particles in the fluid from the difference between the first light scattering and the second light scattering.

In principle, it is not absolutely necessary here to determine the diameter of the particles before or after the fragmentation in the fluid, since it is sufficient to know how much the light scattering changes, since a conclusion as to the concentration or the general presence of the organic particles with the target diameter in the fluid or the air can already be drawn therefrom.

As already indicated, it is particularly advantageous if the wavelength and the intensity of the second light is set or selected in such a manner that the wavelength is in a range which excites the vibration of the organic particles and preferably in a resonance range such that the organic particles with the target diameter in the fluid are set in vibration and are comminuted or fragmented, that is to say decomposed into fragments, by a preferably sufficiently strong vibration.

In an advantageous development, the first light and the second light are in addition in each case a laser light or a laser beam which radiates through the measurement chamber along a first direction.

In particular the second light but the first light as well can be in the UVC range with regard to the respective wavelength, so that, in the case of the use of a laser as light source, a UVC laser can be used.

The first light scattering and the second light scattering are in addition preferably detected orthogonally to the first direction by an optical sensor, wherein the optical sensor is, for example, a camera system for detecting light scattered on the fluid by the Tyndall effect.

The measurement chamber can accordingly be designed, in sections and together with the optical sensor, as a nephelometer and moreover preferably as a nephelometer with a laser as light source for measuring the light scattering.

The first light scattering and the second light scattering as well as the fragmentation of the particles in between should preferably be carried out on the same sample or on the same fluid, in order to be able to obtain comparable results thereby. Therefore, an advantageous variant in addition provides that a flow of the fluid through the measurement chamber, which can be driven in particular by an apparatus provided for this purpose, can be controlled. During the fragmentation and the determination of the first and second light scatterings, the flow is controlled in such a manner that the fluid in the measurement chamber is free of flow and the fragmentation and the determination of the first light scattering and of the second light scattering accordingly are carried out on the same sample or on the same fluid.

Although the measurements of the first and second light scatterings as well as the fragmentation of the organic particles between the measurements of the light scatterings occur offset in time, the entire method can be carried out in a short time, so that it is possible to measure, almost in real time, particles with a determined target diameter, which with high probability are viruses or other pathogens such as bacteria, or to measure their concentration in the air. Here, it does not have to be determined whether the particles in fact are a certain type of particle such as, for example, a determined virus. Rather the purpose is simply early detection and thereupon preferably a warning as to whether there is an excessively high load with possible pathogens. Potential pathogens or viruses are here distinguished from other particles contained in the air by their size.

It is essential that the organic particles with the target diameter, that is to say the potential pathogens, are comminuted or comminuted in great numbers during the exposure to the second light and/or during the exposure to ultrasound, so that a different light scattering arises due to the fragmentation.

The second light can be light in the UV or UVC range, wherein, in the case with sufficiently high intensity, light in the visible spectrum or range can also be used.

Furthermore, it is advantageous that the wavelength of the second light is adapted to the particle or to the organic particles with the target diameter or to the virus, so that the light can excite this particle to a vibration which comminutes or fragments the particle. In addition, the intensity of the second light must be sufficiently high in order to cause sufficient destruction or fragmentation or in order to fragment a sufficient number of particles.

Depending on the diameter of the particle with the target diameter, the wavelength of the second light is, for example, in a range from 100 to 280 nanometers and preferably approximately 120 nanometers, so that the light can be UV light or UVC light.

A specific wavelength and intensity adapted to a particle as well as a possible pulsing of the second light can be determined beforehand by tests, wherein, in the case of the occurrence of new pathogens, the corresponding wavelengths, intensity and, if desired, a preferred pulsing can be established by new tests.

The method can in multiple cases can be carried out repeatedly immediately one after the other or in parallel with different wavelengths and intensities or, in the case of ultrasound, with different frequencies, and correspondingly for particles with different diameters, wherein the sample or the fluid here should be exchanged. Accordingly, by multiple methods according to an example embodiment carried out one after the other or in parallel, different particles with different target diameters and accordingly different pathogens can be detected.

An advantageous development of the method provides an additional step before the binding of the aerosol particles contained in the air in the fluid:

Guiding air into a sized filter by means of which preferably substantially all the aerosol particles having a diameter greater than the target diameter are filtered out, so that filtered air is obtained, which accordingly preferably contains only aerosol particles with a diameter equal to and/or smaller than the target diameter. The result of this is that, during the binding of the aerosol particles contained in the air in the fluid, the fluid contains the aerosol particles with a diameter equal to or smaller than the target diameter, which were previously contained in the filtered air.

By guiding the air into the sized filter, a more precise determination of the concentration then results, since, in the fluid, fewer “interfering” particles with a diameter different from the target diameter are present, which particles can distort the measurement results. Such a sized filter can in addition also consist of multiple successively arranged filters, so that the sized filter substantially is a filter arrangement by which successive particles with a diameter greater than the target diameter can be filtered, before the remaining particles are bound in the fluid.

Preferably, it is provided that by means of such a sized filter, all the particles with a diameter equal to or greater than 300 nanometers can be filtered out, so that only particles with a diameter smaller than 300 nanometers are still present in the fluid.

Since charged and/or uncharged particles are present in the air, the concentration of which is preferably not to be determined depending on the pathogen to be detected, an additional advantageous variant provides that, before the binding of the aerosol particles contained in the air in the fluid, an additional step occurs:

Guiding air into a charge filter, by means of which aerosol particles which have a positive charge and/or aerosol particles which have a negative charge and/or aerosol particles which have no charge are filtered out of the air, so that filtered air is obtained, which preferably accordingly contains only aerosol particles that have a predetermined charge which corresponds to a charge determined by the pathogen to be detected and wherein charge is understood here to refer to a positive charge, to a negative charge as well as to no charge. From this it follows that, during the binding of the aerosol particles contained in the air in the fluid, the fluid substantially contains as particles only the aerosol particles with a predetermined charge that were previously contained in the filtered air as particles.

For the implementation of such a charge filter, for example, an electric field can be used, by means of which the charged particles are deflected from their movement path and thus removed from the air flow. A charge filter implemented in this manner can in addition be combined with one or more sized filters.

In order to filter in a targeted manner a portion of all the aerosol particles from the air, which, however, comprises the particles with the target diameter, an additional advantageous method variation provides that, before the binding of the aerosol particles contained in the air in the fluid, an additional step occurs:

Guiding of air into an inhomogeneous electric field, by means of which polarizable aerosol particles are polarized. Furthermore, the inhomogeneous electric field or an apparatus generating this field is designed to guide the polarized aerosol particles through the inhomogeneous course of the electric field onto a collection apparatus or to deflect them out of their movement path and to collect them on the collection apparatus. The polarized aerosol particles accordingly accumulate on or at the collection apparatus and are bound on said collection apparatus or coming out of said collection apparatus during the binding of the aerosol particles contained in the air in the fluid.

For example, the temperature of the collection apparatus can accordingly be controlled, so that the polarized aerosol particles condense on the collection apparatus. The guiding of the air through the inhomogeneous electric field, which accordingly substantially represents a filtering and collecting of the polarizable particles from the air, can be combined with an upstream charge filter and with one or more upstream sized filters.

If the particles with the predetermined target diameter are not polarizable but have a previously known charge, the collection apparatus can also be formed as a surface with corresponding opposite charge, which attracts the particles with the target diameter and the previously known charge. Such surfaces with corresponding opposite charge and provided as collection apparatus can also be heated.

Preferably, it is provided that the aerosol particles contained in the air are bound during the binding in the fluid by formation of a condensate from the air in the fluid.

In carrying out the method or in the sensor explained below, in order to be able to convey the fluid in a targeted manner, the fluid is driven along the flow path preferably by capillary action and/or by a downstream suction. Such a suction or else such a capillary action can be generated, for example, by a downstream evaporation of the fluid, which occurs fluidically after the measurement of the light scattering or after the measurement chamber. Advantageously, a Peltier element can be used for this purpose, wherein a first cool side is used for the condensation of the fluid and a hot side is used for the evaporation of the fluid.

Regardless of whether a Peltier element or another apparatus is used for the evaporation, it is in addition advantageous that, in particular in the fluid, any pathogens, such as viruses, still present in the form of particles can be rendered harmless by denaturing during the evaporation.

The wavelength of the light emitted by the light source can be settable, for the purpose of which, for example, a corresponding optical system can be provided here. If the wavelength is settable, the light can be adapted to different target sizes or particles of different size, so that on the basis of the settable wavelength, a wide variety of particle sizes and thus a wide variety of potential pathogens can be detected.

In this context, it is also advantageous if the sized filter is settable to different particle sizes, for example, by connecting or disconnecting or else by exchanging different filter stages.

In addition, it is advantageous if the light or the second light for the fragmentation of the particles with the target diameter is pulsed according to an advantageous embodiment of the disclosure, so that during the irradiation with the second light a pulsed light strikes the particles with the target diameter. This is also particularly advantageous since, as a result of the light, naturally not only the particles with the target diameter can be excited by the light to a vibration which destroys the particles, but instead, in principle, all the particles in the samples can be excited, wherein the particles with the target diameter are preferably excited more strongly by the wavelength adapted to the particles with the target diameter. If a continuous irradiation of the samples or of the sample with light occurs, it can happen that, in addition to the particles with the target diameter, additional particles with other diameters are destroyed, since their vibration can also become so strong due to the continuous irradiation that these particles are also comminuted or destroyed. By the pulsing of the light or at least the pulsing of the second light, the particles are allowed to “settle,” so that their vibration can abate and said particles are destroyed less frequently. In the case of a short irradiation duration, as a result of the wavelength set to the particles with the target diameter, more particles with the target diameter are destroyed than other particles. For example, light and laser pulses lasting each approximately 100 femtoseconds are sufficient.

For an exposure of the particles to ultrasound, a pulsing can also be advantageous, since all the particles can settle in the pauses between the pulses, and only the particles with the target diameter are excited to a sufficiently strong vibration which fragments the particles.

For the determination of the concentration or the proportion of the organic particles in the air, it is also possible to detect which air volumes the particles present in the samples or the particles in the fluid were obtained from, so that, by means of the concentration in the sample, a conclusion as to the concentration in the original volume can be drawn.

The determination of the concentration can here also occur using Bayesian statistics.

An additional aspect of an example embodiment of the disclosure relates to an apparatus or to a sensor for carrying out the method according to the example embodiment. For this purpose, the apparatus comprises at least one prefilter and in each case a measurement unit as well as in each case an evaluation unit. The prefilter is designed to guide air comprising organic and/or inorganic aerosol particles to the measurement unit, wherein the measurement unit or the prefilter comprises an apparatus for binding the aerosol particles in a fluid. The measurement unit is such that the fluid can flow through it along a flow path, and the flow or flow rate of the fluid can be controlled. Furthermore, the measurement unit comprises a measurement chamber and a light source, wherein the light source is designed to emit the first light and the second light offset in time with respect to one another with the respective intensity and the respective wavelength into the measurement chamber. The measurement unit furthermore comprises an optical sensor for determining the first light scattering and the second light scattering of the first light on the fluid in the measurement chamber. In addition, the evaluation unit is designed to determine, from a difference between the first light scattering and the second light scattering or from a comparison between the first light scattering and the second light scattering, a concentration of the organic particles with the determined target diameter in the air or in the fluid and, coming therefrom, in the air.

The light source is in addition preferably a laser, and the first and second lights accordingly are each a laser light or a laser beam.

Furthermore, by means of this apparatus, a method for determining a concentration distribution and/or a movement pattern of an aerosol with organic particles with a target diameter or of the organic particles with the target diameter can be carried out in a room. For this purpose, the apparatus has a plurality of units or subunits respectively formed by a prefilter, a measurement unit and an evaluation unit. Furthermore, the units are arranged or distributed according to a predetermined pattern in the room. Due to the predetermined pattern, the coordinates are known, or the arrangement of the units relative to the room is known. From the concentrations of the particles with the target diameter, which can be determined by the individual units, in combination with the arrangement of the respective units according to the pattern, a position of an aerosol cloud in the room is determined, wherein, furthermore, as a result of positions of the aerosol cloud, which are determined successively in time, a previous movement path and, on the basis of an interpolation, a future movement path of the aerosol cloud are determined. The interpolation can here be carried out using a neuronal network or by means of a fluid simulation.

The above disclosed features can be combined as desired, to the extent that this is technically possible and to the extent that said features are not mutually contradictory.

### BRIEF DESCRIPTION OF THE DRAWINGS:

Additional advantageous developments of the example embodiments of the disclosure are characterized in the dependent claims or represented in further detail below based on the figures together with the description of the preferred embodiment of the disclosure the figures. In the figures:

FIG. 1 shows an apparatus for carrying out the method according to an example embodiment of the disclosure; and

FIG. 2 shows a prefilter comprising multiple filter stages according to an example embodiment of the disclosure.

### DETAILED DESCRIPTION OF EXAMPLE EMBODIMENTS:

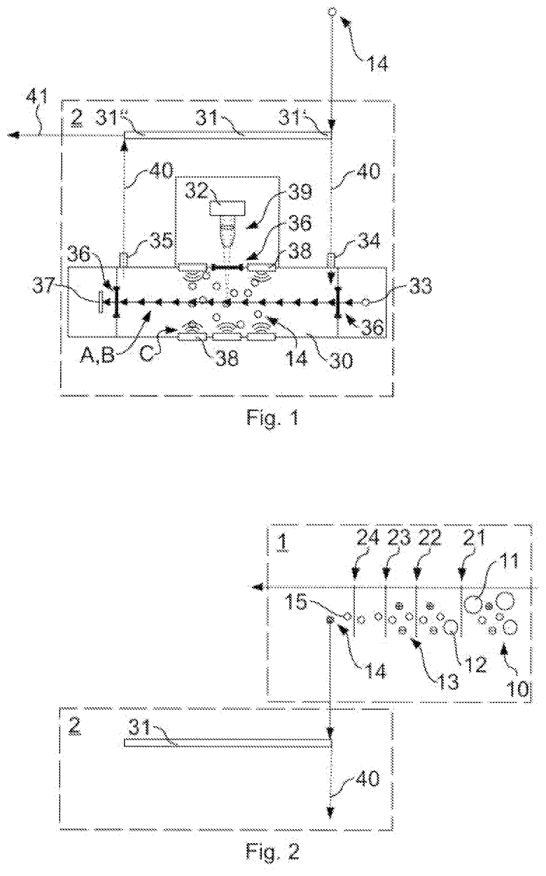

The figures are diagrammatic examples, wherein FIG. 2 shows a prefilter 1 consisting of multiple filter stages, which prefilter can be connected upstream to the apparatus 2 represented in FIG. 1.

The method according to the an example embodiment of the disclosure as well as the associated sensor according to an example embodiment or the associated apparatus according to an example embodiment, which are illustrated diagrammatically in FIG. 1, are used for detecting inorganic and organic particles having a determined diameter, wherein, in a method run, in each case particles 14 with a target diameter can be detected, and this target diameter can be varied substantially by setting the wavelength and the intensity of the light emitted by the light source during the fragmentation of the particles, which corresponds to the second light, as well as by an adaptation of the evaluation based thereon.

The backdrop of example embodiments of the disclosure is the detection of particles with these properties—that is with a previously known diameter which corresponds to the target diameter within a tolerance range—in terms of their concentration and their possible display or issuing of a warning message.

The basic principle consists of the differential measurement of the scattering capability of the particles with their original properties, wherein a particle, which can be a virus, thus has not yet been comminuted, in comparison to the scattering capability of the particles or the particle fragments thereof, which have been irradiated with the second light and comminuted thereby. This difference gives information on the concentration of the particles in the air, which is the basis of the measurement.

According to the proposed method, in order to be able to bind aerosol particles contained in the air in the fluid 40 according to the proposed method, a collection apparatus 31 is provided, which, according to FIGS. 1 and 2, is designed, for example, as a Peltier element, on the cold side 31′ of which the air with the particles can condense, and on the hot side 31″ of which the fluid 40 is evaporated again and discharged again via released air 41. Moreover, by the evaporation on the hot side, a suction is generated, which conveys the flow of the fluid 40 through the inlet 34 of the measurement chamber 30 into the measurement chamber 30 and, after the method, out of the outlet 35 out of the measurement chamber 30, wherein the suction or the flow can be controlled, for example, by a valve which is not shown.

The particles floating in the condensate or in the fluid 40, which can be, for example, the Covid-19 virus or another pathogen, then preferably reach the measurement chamber 30 of the measurement unit 2 due to capillary action. The flow of the fluid 40 is controlled for this purpose in such a manner that the fluid, while the method is carried out, exhibits substantially no flow, that is to say no fluid 40 flows out of the measurement chamber 30 and also no new fluid 40 additionally flows into the measurement chamber 30.

Then, in the measurement chamber 30, due to the light source 33 formed here as a laser, a first light A is emitted through the measurement chamber 30, which light is selected so that the organic particles are not fragmented in the fluid 40. The first light A is scattered as a result of the Tyndall effect on the particles or on all the particles in the fluid 40 in the measurement chamber 30, wherein the light scattering is measured by the optical sensor 32. In the present case, the optical sensor 32 is formed as a camera system for image processing of the Tyndall scattering with an upstream camera tube 39, in which a camera optical system for focusing the image recorded by the camera system is arranged. Here, the camera system or the optical sensor 32 is darkened with respect to the surrounding environment and only connected via a light-permeable window 36 to the measurement chamber, wherein the window 36 does not reflect light or is reflection-free, so that the measurement is not distorted by the optical sensor 32.

The laser or the light source 33 as well is separated from the measurement chamber 30 by means of such a window 36, wherein the laser beam or the first and second lights A, B in turn exit from the measurement chamber 30 on the opposite side of the measurement chamber 30 through such a window 36 and strike an absorber 37, by means of which the light can be absorbed and preferably the strength or the intensity of the light can also be measured, which facilitates or allows the control of the light source 33.

After the first light scattering has been measured by means of the optical sensor 32, the fragmentation of the organic particles in the fluid 40 occurs, which is brought about by an exposure of the fluid 40 to the second light B and here, in addition, by the exposure of the fluid 40 to ultrasound C. For this purpose, within the measurement chamber 30, multiple ultrasound generators 38 are additionally provided, which generate ultrasound C at least in the region relevant to the measurement of the light scattering and thereby contribute to the fragmentation of the organic particles in the fluid 40.

Here, all the particles in the fluid 40 are exposed to the second light B as well as to the ultrasound C, wherein, due to the adjustment of the intensity and the wavelength of the second light B and of the frequency of the ultrasound C in connection with an optional pulsing of the ultrasound C and of the second light B, in particular the organic particles with the target diameter are fragmented, and, for example, any inorganic particles or particles with smaller diameter than the target diameter that are present are not fragmented.

After the fragmentation, which can be carried out for a predetermined time, a second measurement of the light scattering occurs, wherein the second light scattering measured here is compared to the first light scattering. From the difference between the light scatterings, a conclusion can be drawn as to whether and how many particles have been fragmented and accordingly how many organic particles with the target diameter are or were present in the fluid 40.

Since the quantity of air the fluid 40 was obtained from is known, the proportion of the organic particles with the target diameter in the air and whether this proportion or this concentration exceeds a predetermined limit value can be determined.

In FIG. 2, a prefilter 1 provided for the collection and cleaning of the air is represented. A plurality of different particles 11, 12, 13, 14 are collected, which are contained in the air 10. The particles 11, 12, 13, 14, which are usually in fluid droplets, in the aerosol, are bound for this purpose in a fluid 40.

In the present case, a first sized filter 21 is provided as coarse filter which filters particles 11 which are substantially larger than particles 14 with the target diameter. Next in flow direction of the air 10, a second sized filter 22 is provided as fine filter, which filters particles 12 which have a diameter greater than the target diameter and a diameter smaller than the particles 11 filtered by the first sized filter 21. Subsequently, a charge filter 23 is provided, which, for example, is implemented by a targeted electric field, by which all the positively or negatively charged particles 13 are filtered from the air, wherein said particles, due to the first and second sized filters 21, 22, have a diameter equal to or smaller than the target diameter. Depending on the environmental conditions or the target diameter of the particle, additional filters and, for example, more sized filters, can also be provided additionally. The remaining particles are polarized to the extent possible by the apparatus 24. The polarized particles 14 are deflected by the apparatus 24, for example, an inhomogeneous electric field, onto a collection apparatus and are collected on said collection apparatus for further analysis. The particles 15 remaining in the air can be expelled again, since they are of no interest for the analysis. The particles 14 collected in this way for further analysis are all the particles which were not filtered out previously by the different filters or filter stages, so that, in addition to the organic particles with the target diameter, the proportion of which in the air is to be determined, additional particles can also be bound in the fluid. The air flow can be driven through the prefilter 1 or through the filter and the polarization apparatus by a fan, not shown, which generates a continuous air flow with a preferably known volume flow. By means of the first and second sized filters 21, 22, preferably all the particles having a diameter greater than the target diameter, that is to say greater than the potential virus diameter of, for example, 300 nm, are filtered out.

Example embodiments of the disclosure are not limited to the above indicated preferred embodiment examples. Instead, a number of variants are conceivable, which use the represented solution even in embodiments of fundamentally different type.

1. A method for detecting a concentration of organic particles (14), in particular viruses, with a determined target diameter in air (10) which comprises organic and/or inorganic aerosol particles,
wherein aerosol particles contained in the air (10) are bound in a fluid (40), so that said aerosol particles are contained as particles in the fluid (40),
wherein the fluid (40) with the particles contained therein is exposed in a measurement chamber (30) to a second light (B) fragmenting the organic particles and/or to an ultrasound (C) fragmenting the organic particles, so that the organic particles are fragmented in the fluid (40),
wherein before the fragmentation of the organic particles, a first light scattering of a first light (A) and after the fragmenting of the organic particles, a second light scattering of the first light (A) on the fluid (40) are determined, and, from a difference between the first light scattering and the second light scatterings, the concentration of the organic particles (14) in the fluid (40) and thus in the air is determined.

2. The method according to claim 1,
wherein the fragmentation of the organic particles as well as the determination of the first light scatterings and of the second light scattering are carried out offset in time with respect to one another in a single measurement chamber (30).

3. The method according to claim 1, comprising the steps in the following order:
a) binding aerosol particles contained in air (10) in the aqueous fluid (40), so that the fluid (40) contains the aerosol particles previously contained in the air (10) as particles;
b) guiding the fluid (40) into the measurement chamber (30), which can be exposed to light (A, B) emitted by a light source (33);
c) exposing the fluid (40) in the measurement chamber (30) to the first light (A) of first intensity and first wavelength, wherein the first intensity and the first wavelength are selected so that no organic particles are fragmented by the first light (A);
d) determining the first light scattering of the first light (A) on the fluid (40) in the measurement chamber (30);
e) exposing the fluid (40) in the measurement chamber (30) to the second light (B) of second intensity and second wavelength, wherein the second intensity and the second wavelength are selected so that the organic particles are fragmented by the second light (B), and/or exposing the fluid (40) in the measurement chamber (30) to ultrasound (C), wherein a frequency of the ultrasound is selected in such a manner that the organic particles are fragmented;
f) exposing the fluid (40) in the measurement chamber (30) to the first light (A);
g) determining the second light scattering of the first light (A) on the fluid (40) in the measurement chamber (30);
h) determining the difference between the first light scattering and the second light scattering, and determining the concentration of the organic particles (14) in the fluid (40) from the difference between the first light scattering and the second light scattering.

4. The method according to claim 3,
wherein the wavelength and the intensity of the second light (B) are set or selected in such a manner that the wavelength is in a range which excites a vibration of the organic particles (14), so that the organic particles (14) with the target diameter in the fluid (40) are set in vibration and comminuted.

5. The method according to claim 3,
wherein the first light (A) and the second light (B) are each a laser beam which radiates through the measurement chamber (30) along a first direction.

6. The method according to claim 1,
wherein the first light scattering and the second light scattering are detected orthogonally to the first direction by an optical sensor (32).

7. The method according to claim 6,
wherein the optical sensor (32) is a camera system for detecting a light scattered by the Tyndall effect on the fluid (40).

8. The method according to claim 1,
wherein a flow of the fluid (40) through the measurement chamber (30) is controllable and is controlled during the fragmentation and the determination of the first and second light scatterings in such a manner that the fluid (40) is free of flow in the measurement chamber (30).

9. The method according to claim 1,
furthermore comprising, before the binding of the aerosol particles contained in the air (10) in the fluid (40), the step:
guiding air in a sized filter (21, 22) by which aerosol particles (11, 12) having a diameter greater than the target diameter are filtered out, so that filtered air is obtained, which contains aerosol particles with a diameter equal to and/or smaller than the target diameter, so that the fluid (40), during the binding of the aerosol particles contained in the air (10) in the fluid (40), contains the aerosol particles with a diameter equal to or smaller than the target diameter that were previously contained in the filtered air.

10. The method according to claim 1,
furthermore comprising, before the binding of the aerosol particles contained in the air (10) in the fluid (40), the step:
guiding air into a charge filter (23), by means of which aerosol particles which have a positive charge and/or aerosol particles which have a negative charge and/or aerosol particles which have no charge are filtered out of the air (10), so that filtered air is obtained, which contains aerosol particles with a predetermined charge, so that, during the binding of the aerosol particles contained in the air (10) in the fluid (40), the fluid (40) contains as particles the aerosol particles with a predetermined charge that were previously contained in the filtered air.

11. The method according to claim 1,
furthermore comprising, before the binding of the aerosol particles contained in the air (10) in the fluid (40), the step:
guiding air (10) into an inhomogeneous electric field (24) by means of which polarizable aerosol particles are polarized and which is designed to guide the polarized aerosol particles onto a collection apparatus,
wherein the polarized aerosol particles accumulate on the collection apparatus and are bound on said collection apparatus or coming out of said collection apparatus during the binding of the aerosol particles contained in the air (10) in the fluid (40).

12. The method according to claim 1,
wherein the aerosol particles contained in the air (10), during the binding in the fluid (40), are bound by formation of a condensate from the air in the fluid (40).

13. The method according to claim 1,
wherein the first light and/or the second light (44) is/are pulsed during the irradiation of the fluid (40).

14. An apparatus for carrying out the method according to claim 1,
comprising at least one prefilter (1) and in each case a measurement unit (2) as well as in each case an evaluation unit,
wherein the prefilter (1) is designed to guide air (10) comprising organic and/or inorganic aerosol particles to the measurement unit (2),
wherein the measurement unit (2) or the prefilter (1) comprises an apparatus (31) for binding the aerosol particles in a fluid (40)
wherein the fluid (40) can flow through the measurement unit along a flow path and the flow of the fluid (40) is controllable,
wherein the measurement unit (2) comprises a measurement chamber (30) and a light source (33),
wherein the light source (33) is designed to emit the first light (A) and the second light (B) with the respective intensity and the respective wavelength offset in time with respect to one another,
wherein the measurement unit (2) furthermore comprises an optical sensor (32) for determining the first light scattering and the second light scattering of the first light (A) on the fluid (40) in the measurement chamber (30),
and wherein the evaluation unit is designed to determine, from a difference between the first light scattering and the second light scattering, a concentration of the organic particles (14) having the determined target diameter in the air (10).

15. A method for determining a concentration distribution and/or a movement pattern of an aerosol with organic particles with a target diameter in a room using the apparatus according to the preceding claim,
wherein the apparatus comprises a plurality of units respectively formed by a prefilter (1), a measurement unit (2) and an evaluation unit, and wherein the units are arranged according to a predetermined pattern in the room,
wherein, from the concentrations of the particles (14) with the target diameter, which concentrations can be determined by the individual units, in combination with the arrangement of the respective units according to the pattern, a position of an aerosol cloud in the room is determined,
wherein, as a result of positions of the aerosol cloud, which are determined successively in time, a previous movement path and, on the basis of an interpolation, a future movement path of the aerosol cloud are determined.
